(19) United States
(12) Patent Application Publication
(10) Pub. No.: US 2008/0088559 A1
(43) Pub. Date: Apr. 17, 2008

(54) Method for driving display panel

(76) Inventors: Ming-Sheng Lai, Hsin-Chu (TW); Min-Feng Chiang, Hsin-Chu (TW); Ching-Ting Kuo, Hsin-Chu (TW); Hsueh-Ying Huang, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/882,349

(22) Filed: Aug. 1, 2007

(30) Foreign Application Priority Data
Oct. 16, 2006 (TW) 095138292

(51) Int. Cl. G09G 3/36

(52) U.S. Cl. 345/89

(57) ABSTRACT

Disclosed is a method for driving a display panel. The display panel includes a plurality of unit pixels and a plurality of switches. The switches are used for controlling the unit pixels to display. The method includes transmitting a plurality of gate signals to the switches for driving the switches. More, the driving method also includes transmitting a plurality of data signals to the switches for providing a plurality of pixel voltages to the unit pixels and providing common voltages to the unit pixels as well as generating the potential differences with the common voltage and the pixel voltages of the unit pixels for controlling the display of the unit pixels by a group time. The total amount of potential differences in each unit pixel in the group time is substantially equal to zero. The group time includes a plurality of driving unit times. In each driving unit time, at least one group of pixels displays. A group of pixels includes a plurality of grayscale levels of brightness. The total brightness of the grayscale levels accords with a predetermined brightness. Therefore, the display not only can increase its viewing angel, but also can avoid residual image caused from residual charge.

### BACKGROUND OF THE INVENTION

1. Field of the Invention

The present invention relates to a driving method and, more particularly, to a method for driving a display panel.

2. Description of the Prior Art

According to current development of flat panel display (FPD) technology, different FPD manufacturers are continuously developing different kinds of display panels, such as liquid crystal display (LCD), plasma display panel (PDP), and organic light emitting diode (OLED). In the current display panels, no matter the display is twisted nematic-LCD (TN-LCD), multi-domains vertical alignment-LCD (MVA-LCD), or in-plane switch-LCD (IPS-LCD), users will find color distortion phenomenon while viewing frames in large viewing angel. The reason is that the alignment angle of the liquid crystal causes changes of brightness and gamma curve in the large viewing angle. Therefore, the color through large viewing angel is different from the color through centering angle while users viewing. In other words, users only can view color frames with normal brightness within certain viewing angle. If users view the display panel outside the certain viewing angle, the frames with color distortion is appeared because of the brightness difference. As a result, users are restricted to view the display panel.

Referring to FIG. 1A and FIG. 1B, the figures are two conventional layouts of display panels showing the brightness and polarities of the frames. FIG. 1A and FIG. 1B illustrate the 1^{st} frame and the 2^{nd} frame, respectively. As can be seen from the figures, the plurality of pixels of the 1^{st} frame and the 2^{nd} frame conform to two different gammas (γ₁, γ₂). In other words, two potential differences are used to control the pixels of each frame for a display panel to achieve multi-domains purpose of the liquid crystal. The + and − of the brackets in each pixel of the figure individually illustrate the polarities in the potential differences. Besides, in order to avoid different brightness (such as two level of the brightness) appearing in some pixels of frames while users viewing frames in the display panel, the pixels in the 1^{st} frame should compensate for the pixels in the 2^{nd} frame. Further, by a fast change between two frames, users cannot observe that these frames have different brightness.

According to FIG. 1A and FIG. 1B, the pixels of two frames in the same position do not have identical voltages, and the total amount of the potential differences is not equal to zero. The detailed description is described in accordance with FIG. 2. FIG. 2 is a waveform showing the pixels of the 1^{st} frame and the 2^{nd} frame in the potential differences. The pixel R1C1 of the 1^{st} frame and the pixel R1C1 of the 2^{nd} frame are described in the follows. As shown from the figure, the potential difference for the pixel R1C1 of the 1^{st} frame is corresponding to the 1^{st} positive voltage (+1) of the 1^{st} gamma γ₁, and the potential difference for the pixel R1C1 of the 2^{nd} frame is corresponding to the 2^{nd} negative voltage (−2) of the 2^{nd} gamma γ₂, in which the brightness of the 1^{st} gamma γ₁ is greater than the brightness of the 2^{nd} gamma γ₂. Therefore, the 1^{st} positive voltage (+1) must be greater than the 2^{nd} negative voltage (−2). In other words, the total amount of the potential differences is not equal to zero while the pixels R1C1 of two frames are in the same position. Therefore, the residual charge will happen. While lasting a period of time, the residual image is appeared on the display panel while viewing images. According to the above description, the driving method of the conventional display panel improves the brightness difference in different viewing angels of the display panel. However, the residual image results in the display panel while viewing frames. The display quality of the display panel is decreased, and causes a bad visual feeling while viewing the display panel.

### SUMMARY OF THE INVENTION

One object of the present invention is to provide a method for driving a display panel. By displaying different brightness from the pixels of the frames in the display panel, the image distortion caused from different viewing angles will be eliminated as well as the viewing angle of the display panel can be enhanced.

Another object of the present invention is to provide a method for driving a display panel. The total amount of the potential differences of each pixel in a group time can be substantially equal to zero, and to avoid the residual image resulting in the frame.

One object of the present invention is to provide a method for driving a display panel. Since a group of pixels having unit pixels with different brightness, a predetermined brightness can be performed in a group time. In other words, the different brightness of the group of pixels can perform the predetermined brightness in the group time.

The present invention is to provide a method for driving a display panel. The display panel has a plurality of unit pixels to display the frames. The display of these unit pixels is controlled by a plurality of switches. The method of the present invention is to transmit a plurality of gate signals. These gate signals can drive these switches, and to transmit a plurality of data signals to these switches. Further, it can provide a plurality of pixels voltages to these unit pixels, and generate the potential differences with the common voltages of the unit pixels. As a result, these unit pixels are controlled to display in the group time. The data signals corresponding to these unit pixels are the brightness signals corresponding to different gammas, and can enhance the viewing angle of the display panel. Besides, the total amount of the potential differences of each unit pixel under the group time is substantially equal to zero. Therefore, the residual image doesn't results in the display panel while viewing frames and the display quality of the display panel is enhanced. More, the group time includes a plurality of driving unit times. At least one group of pixels displays in each the driving unit time.

In the following description, the present invention is described on the basis of a number of variant examples covered by the present invention, with reference to the accompanying drawings. Other features and advantages of the present invention will become apparent from the following detailed description of the invention made with reference to the accompanying drawings.

### BRIEF DESCRIPTION OF THE DRAWINGS

FIG. 1A and FIG. 1B are two conventional layouts of display panels showing brightness and polarities of frames;

FIG. 2 is a waveform showing the frames of conventional display panels under potential differences;

FIG. 3 is one of the preferred embodiments in the present invention showing a circuit diagram;

FIG. 4A to FIG. 4D are preferred embodiments of the present invention showing brightness and polarities of frames;

FIG. 4E is one preferred embodiment of the present invention showing a waveform diagram of data signals;

FIG. 5A to FIG. 5D are another preferred embodiments of the present invention showing brightness and polarities of frames;

FIG. 5E is one preferred embodiment of the present invention showing a waveform diagram of data signals;

FIG. 6A to FIG. 6D are another preferred embodiments of the present invention showing brightness and polarities of frames;

FIG. 6E is another preferred embodiment of the present invention showing a waveform diagram of data signals;

FIG. 7A to FIG. 7D are another preferred embodiments of the present invention showing brightness and polarities of frames;

FIG. 7E is another preferred embodiment of the present invention showing a waveform diagram of data signals;

FIG. 8A to FIG. 8D are another preferred embodiments of the present invention showing brightness and polarities of frames;

FIG. 8E is another preferred embodiment of the present invention showing a waveform diagram of data signals;

FIG. 9A to FIG. 9D are another preferred embodiments of the present invention showing brightness and polarities of frames;

FIG. 9E is another preferred embodiment of the present invention showing a waveform diagram of data signals;

FIG. 10A to FIG. 10F are another preferred embodiments of the present invention showing brightness and polarities of frames;

FIG. 10G is another preferred embodiment of the present invention showing a waveform diagram of data signals;

FIG. 11A to FIG. 11D are another preferred embodiments of the present invention showing brightness and polarities of frames;

FIG. 11E is another preferred embodiment of the present invention showing a waveform diagram of data signals;

FIG. 12A to FIG. 12D are another preferred embodiments of the present invention showing brightness and polarities of frames;

FIG. 12E is another preferred embodiment of the present invention showing a waveform diagram of data signals;

FIG. 13 is one preferred embodiment of the present invention showing a circuit diagram;

FIG. 14 is another preferred embodiment of the present invention showing a circuit diagram;

FIG. 15 is one preferred embodiment of the present invention showing a waveform diagram of data signals;

FIG. 16 is another preferred embodiment of the present invention showing a waveform diagram of data signals;

FIG. 17 is another preferred embodiment of the present invention showing a waveform diagram of data signals; and

FIG. 18 is a block diagram as one preferred embodiment showing a display device of the present invention set in a photonic device.

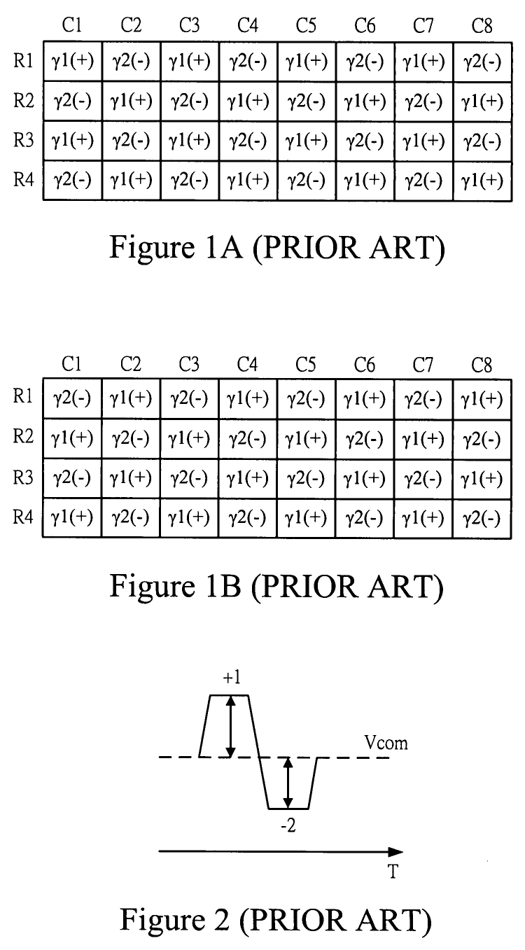

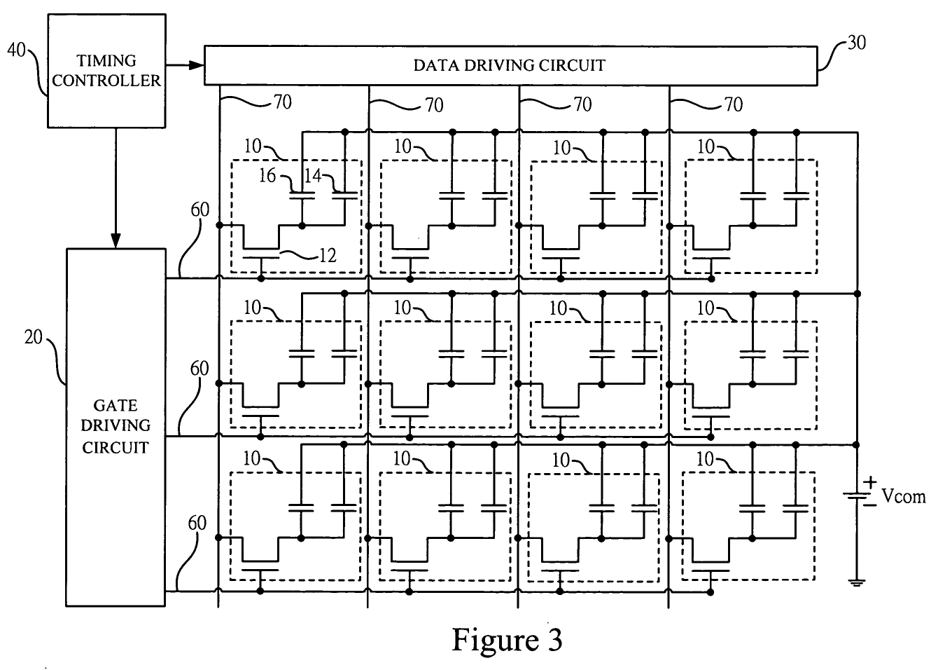

### DETAILED DESCRIPTION OF THE PREFERRED EMBODIMENT

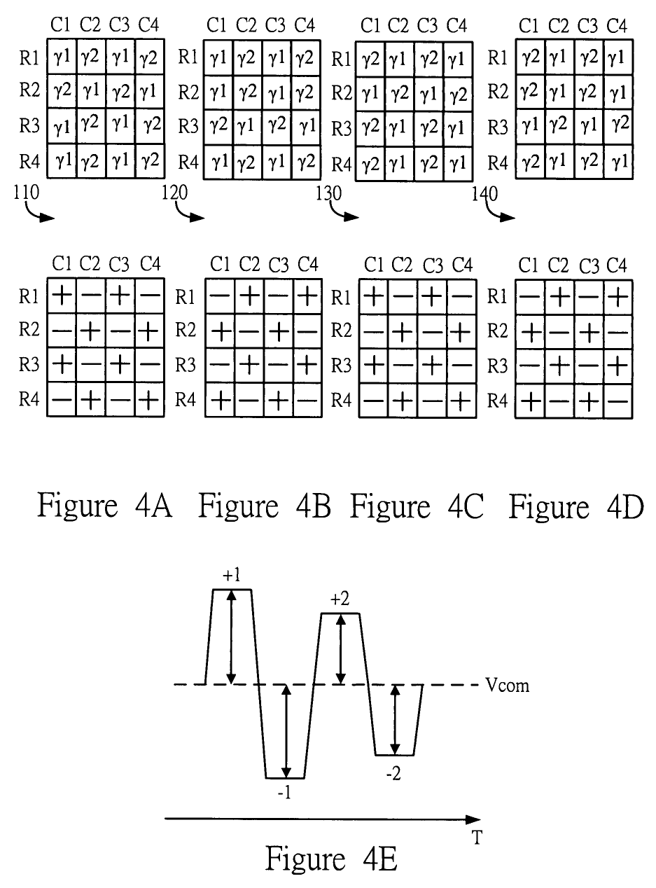

First, refer to FIG. 3. FIG. 3 is one of the preferred embodiments in the present invention showing a circuit diagram. As shown in the figure, the display panel of the present invention comprises a plurality of unit pixels 10, a gate driving circuit 20, a data driving circuit 30, a timing controller 40, and a common voltage source Vcom. The gate driving circuit 20 is coupled with a plurality of gate lines 60, and the data driving circuit 30 is coupled with a plurality of data lines 70. These gate lines 60 are arranged (or layout) in rows, and these data lines 70 are arranged (or layout) in columns and also substantially interlaced with these gate lines 60 to form the unit pixels 10. The unit pixels 10 comprise a frame. Each unit pixel 10 comprises a switch 12, a storage capacitor 14, and a liquid crystal capacitor 16. The switch 12 is used to control the unit pixels 10 for display. The switch 12 can be a transistor (such as thin film transistor, for example, bottom gate type, top gate type, or others), but not-limited it to above description. The storage capacitor 14 and the liquid crystal capacitor 16 are individually coupled with the switch 12. More, the storage capacitor 14 and the liquid crystal capacitor 16 are coupled with the common voltage source Vcom. One end of the liquid crystal capacitor 16 coupled with the common voltage source Vcom is a common electrode of each unit pixel 10. The other end of the liquid crystal capacitor 16 is a pixel electrode of each unit pixel 10. The switch 12 in each unit pixel 10 is coupled with the gate line 60 and the data line 70.

The timing controller 40 is coupled with the gate driving circuit 20 and the data driving circuit 30 in order to transmit the timing signals to the gate driving circuit 20 and the data driving circuit 30. The gate driving circuit 20 individually transmits a plurality of gate signals to the switches 12 of the unit pixels 10 through the gate lines 60 according to the received timing signals, and to drive the switches 12. Since the brightness of the unit pixels 10 is controlled by the potential differences between the voltage of the pixel electrode and the voltage of the common electrode, the data driving circuit 30 will transmit a plurality of data signals to the switches 12 through the data lines 70 according to the timing signals. The data signals are adapted to provide the pixel voltage to the pixel electrode of each unit pixel 10, respectively. The potential difference is generated from the pixel voltage and the common voltage of the common electrode in each unit pixel 10 as well as to individually control the display brightness of each unit pixel 10. The data signals can be brightness signals. In other words, the data signals are corresponding to the voltage signals of different grayscale levels. The data signals of potential differences are individually corresponding to different grayscale levels.

In order to overcome the residual image phenomenon which is caused from residual charge resulting in the display panel, the data signals transmitted from the data driving circuit 30 of the present invention are not only for the brightness signals with different brightness but also for having different polarities. By using the brightness signals with different brightness and polarities in accordance with the time, the total amount of potential differences of each unit pixel 10 in a group time can be substantially equal to zero in case the unit pixels 10 of a plurality of frames are in the same position. In other words, the total amount of potential differences of each unit pixel in the group time is substantially equal to zero in order to avoid resulting residual charge. Therefore, it can overcome conventional residual image problem happened in the display panel. The above group time includes a plurality of driving unit times. The driving unit time is the time of displaying a single frame or a sub-frame. The driving unit time is the time of displaying a plurality of frames or a plurality of sub-frames.

Besides, the method of the present invention can actuate at least a group of pixels of the frame displayed in the driving unit time to represent the predetermined brightness. A group of pixels include a plurality of the unit pixels 10. The present invention uses the data signals with different brightness to control the brightness of the unit pixels 10 in the group of pixels. By using the unit pixels 10 with different brightness, it can make the group of pixels represent the predetermined brightness. The above mentioned group of pixels can be combined from any number of the unit pixels 10, for example one unit pixel, two unit pixels, three unit pixels, and so on, preferred the group of pixels has at least two unit pixels, and represent the predetermined brightness.

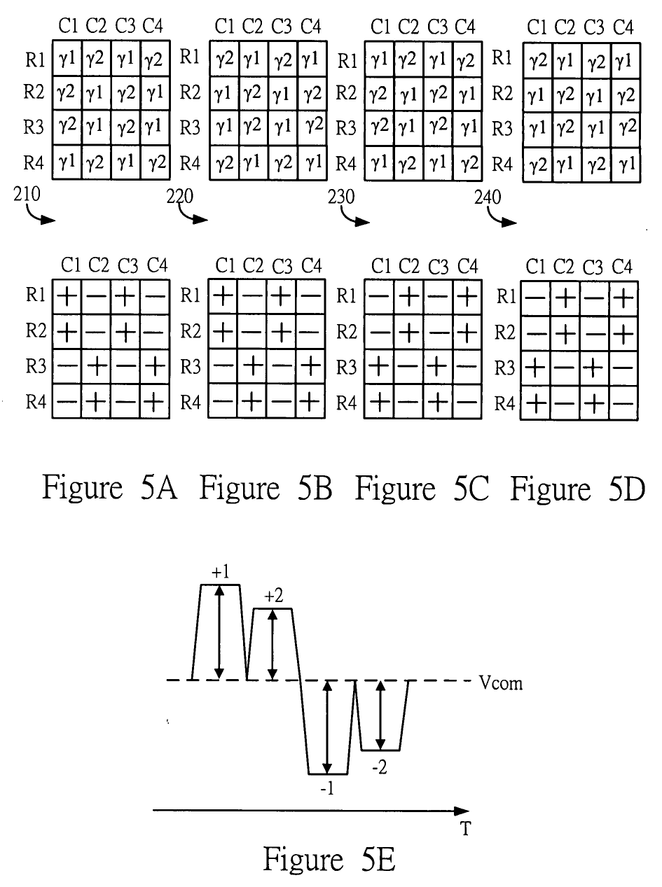

The following preferred embodiments are described in details for the present invention. Referring from FIG. 4A to FIG. 4E, FIG. 4A to FIG. 4D are the arrangements (layouts) showing the brightness and the polarities of the 1^{st} frame 110, the 2^{nd} frame 120, the 3^{rd} frame 130, and the 4^{th} frame 140. The preferred embodiments show the group time comprising the time of displaying 4 frames. In other words, the group time include 4 driving unit times. The present invention in order to achieve multi-domain purpose for enhancing the viewing angle as well as to avoid residual charge resulting in the unit pixels, the unit pixels of each frame (110, 120, 130, and 140) conform to data signals with different brightness and different polarities. The preferred embodiments use 4 data signals to arrange (or layout) the unit pixels of each frame (110, 120, 130, and 140). The 4 data signals individually are the 1^{st} positive brightness signal, the 1^{st} negative brightness signal, the 2^{nd} positive brightness signal, and the 2^{nd} negative brightness signal. The 1^{st} positive brightness signal and the 1^{st} negative brightness signal are all corresponding to the 1^{st} gamma γ₁. In other words, the potential differences between the pixel voltages and common voltages are substantially identical, but the polarities are opposite. More, with the same way, the 2^{nd} positive brightness signal and the 2^{nd} negative brightness signal are all corresponding to the 2^{nd} gamma γ₂, and the polarities are opposite. However, the 2^{nd} gamma γ₂ is not substantially equal to the 1^{st} gamma γ₁. If the brightness of the signal corresponding to the 1^{st} gamma γ₁ wants to be substantially greater than the brightness of the signal corresponding to the 2^{nd} gamma γ₂, the brightness corresponding to the unit pixels essentially can be made to substantially unequal. In other words, the unit pixels can be corresponding to different gammas γ with substantially different brightness.

The preferred embodiments use the data signals which are corresponding to the 1^{st} gamma γ₁ and the 2^{nd} gamma γ₂ to arrange (or layout) the unit pixels of each frame (110, 120, 130, and 140) are for the brightness of some unit pixels of each frame (110, 120, 130, and 140) corresponding to the 1^{st} gamma γ₁ and for the brightness of some unit pixels of each frame (110, 120, 130, and 140) corresponding to the 2^{nd} gamma γ₂. Therefore, each frame (110, 120, 130, and 140) can be divided into a plurality of domains for enhancing the viewing angle of the display panel. Besides, by coordinating the unit pixels corresponding to the 1^{st} gamma γ₁ and the unit pixels corresponding to the 2^{nd} gamma γ₂, a group of pixels of each frame can represent the brightness is adapted in with the predetermined gamma. Therefore, the frame can represent the predetermined brightness. Further, by collocating the frames or sub-frames with different brightness under a plurality of driving unit times, the display panel can represent the predetermined brightness.

The unit pixels of the frames (110, 120, 130, and 140) in the same position as shown from FIG. 4A to FIG. 4D can be arrangements (or layouts) according to the timing of FIG. 4E. The signals +1, −1, +2, −2 of potential differences in FIG. 4E are the 1^{st} positive brightness signal, the 1^{st} negative brightness signal, the 2^{nd} positive brightness signal, and the 2^{nd} negative brightness signal, respectively. For example, the data signals corresponding to the unit pixels R1C1 of each of the 4 frames (110, 120, 130, and 140) are determined by FIG. 4E, and are the 1^{st} positive brightness signal +1, the 1^{st} negative brightness signal −1, the 2^{nd} positive brightness signal +2, and the 2^{nd} negative brightness signal −2, respectively. As shown in FIG. 4E, the total amount of the potential differences in 4 brightness signals is substantially equal to zero. Therefore, after the display panel displaying 4 frames (110, 120, 130, and 140) in the group time, the total amount of the potential differences in the unit pixels R1C1 of the 4 frames (110, 120, 130, and 140) can be substantially equal to zero. In other words, the total amount of the potential differences in the unit pixels R1C1 of the 4 frames is substantially equal to zero. Further, the unit pixels R1C1 will not have residual charge, and the residual image can be avoided.

More, the data signals corresponding to the other unit pixels of the frames (110, 120, 130, and 140) in the same position besides to the above mentioned unit pixels are also arrangements (or layouts) according to FIG. 4E. However, the data signals arranged (or layout) according to the timing of FIG. 4E does not require arranging starting from the 1^{st} positive brightness signal +1. For example, the data signals corresponding to the unit pixels R2C1 of the frames (110, 120, 130, and 140) are the 2^{nd} negative brightness signal −2, the 1^{st} positive brightness signal +1, the 1^{st} negative brightness signal −1, and the 2^{nd} positive brightness signal +2, respectively. Besides, the data signals corresponding to the unit pixels of the frames (110, 120, 130, and 140) in the same position are not required being arranged (or layout) from the left to the right according to the timing of FIG. 4E. For example, the data signals corresponding to the unit pixels R1C2 of the frames (110, 120, 130, and 140) are the 2^{nd} negative brightness signal −2, the 2^{nd} positive brightness signal +2, the 1^{st} negative brightness signal −1, and the 1^{st} positive brightness signal +1, respectively.

The brightness of the unit pixels in the 1^{st} frame 110 can be freely arranged (or layout) to the 1^{st} gamma γ₁ and the 2^{nd} gamma γ₂. In other words, the ratio of the total brightness of the 1^{st} positive brightness signal and the 1^{st} negative brightness signal corresponding to the 1^{st} gamma γ₁ to the total brightness of the 2^{nd} positive brightness signal and the 2^{nd} negative brightness signal corresponding to the 2^{nd} gamma γ₂ can be any number. As long as the brightness of a group of pixels in the 1^{st} frame 110 can achieve the predetermined brightness as well as the brightness of the 1^{st} frame can represent the predetermined brightness, the average brightness is substantially identical in each frame. Besides, the polarities of the unit pixels in the 1^{st} frame can also be freely arranged (or layout). In other words, the unit pixels of the starting 1^{st} frame 110 can freely coordinated with the 1^{st} positive brightness signal, the 1^{st} negative brightness signal, the 2^{nd} positive brightness signal, and the 2^{nd} negative brightness signal.

The definition of gamma in the present invention is a corresponding relationship between brightness and grayscale level. Although the above 1^{st} gamma γ₁ and the 2^{nd} gamma γ₂ are substantially different, the brightness corresponding to certain grayscale levels can be substantially identical.

One preferred embodiment of the data signals in the present invention corresponding to the unit pixels of the frames in the driving unit time is that the data signals corresponding to any 4 of adjacent the unit pixels by 2×2 in the frames are any combination from the 1^{st} positive brightness signal, the 1^{st} negative brightness signal, the 2^{nd} positive brightness signal, and the 2^{nd} negative brightness signal. In other words, the data signals corresponding to any 4 of the adjacent unit pixels by 2×2 in the frames must include the 1^{st} positive brightness signal, the 1^{st} negative brightness signal, the 2^{nd} positive brightness signal, and the 2^{nd} negative brightness signal. The most preferred embodiment of a group of pixels in the present invention is 4 unit pixels as a group of pixels in order to control the brightness of the frame. However, the present invention is not limited to above description. When determining the arrangements (or layouts) of the brightness and polarities of the unit pixels in the 1^{st} frame 110, the brightness and polarities of the unit pixels in the frames (110, 120, 130, and 140) cab be accomplished in accordance with the timing of FIG. 4E.

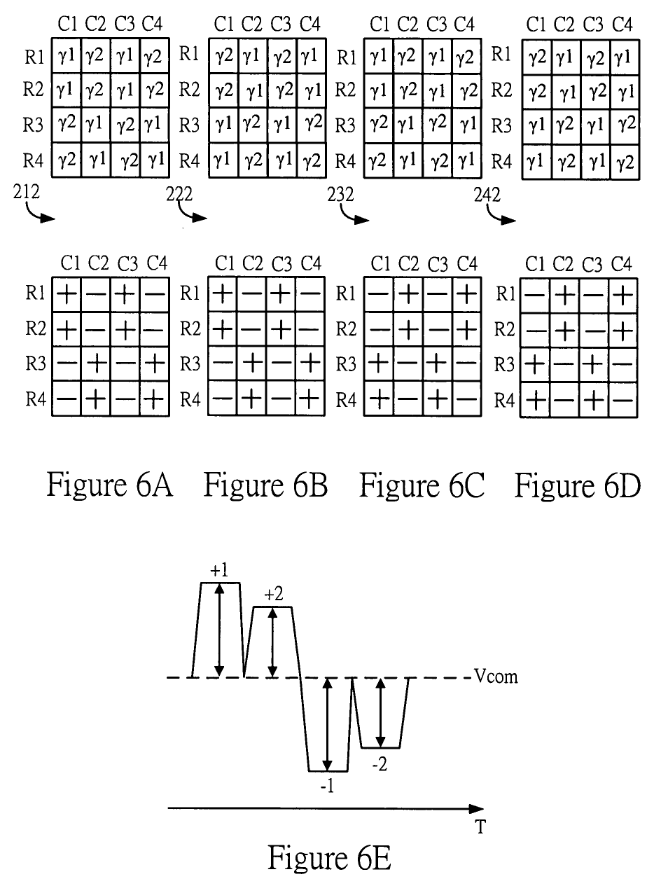

Referring from FIG. 5A to FIG. 5E, FIG. 5A to FIG. 5D are another preferred embodiments of the present invention showing brightness and polarities of frames. FIG. 5E is one preferred embodiment of the present invention showing a waveform diagram of data signals. The preferred embodiments include the 1^{st} frame 210, the 2^{nd} frame 220, the 3^{rd} frame 230, and the 4^{th} frame 240. The preferred embodiments also use the 1^{st} positive brightness signal, the 1^{st} negative brightness signal, the 2^{nd} positive brightness signal, and the 2^{nd} negative brightness signal to arrange (or layout) the unit pixels of 4 frames (210, 220, 230, and 240). The present preferred embodiments different from foregoing preferred embodiments are that the timing arrangement (or layout) of FIG. 5E is substantially different from the timing arrangement (or layout) of FIG. 4E. Further, the data signals of the unit pixels in the frames (210, 220, 230, and 240) as shown from FIG. 5A to FIG. 5D are according to the timing arrangement (or layout) of FIG. 5E.

There are some differences between FIG. 4E and FIG. 5E. The timing of FIG. 4E shows that the data signals of pre-two driving unit times have substantially identical brightness, and the data signals of post-two driving unit times have substantially identical brightness. However, the timing of FIG. 5E shows that the data signals of the adjacent driving unit times have substantially different brightness. As shown in FIG. 4E, the 1^{st} positive brightness signal is adjacent to the 1^{st} negative brightness signal, and the 2^{nd} positive brightness signal is adjacent to the 2^{nd} negative brightness signal. However, as shown in FIG. 5E, the 1^{st} positive brightness signal is adjacent to the 2^{nd} positive brightness signal, and the 1^{st} negative brightness signal is positioned between the 2^{nd} positive brightness signal and the 2^{nd} negative brightness signal. One of the best preferred embodiments in the present invention is a group of the pixel includes the four unit pixels. However, the present invention is not limited to the above description. According to the above preferred embodiments, the data signals corresponding to the unit pixels within the group time in the present invention can be any combination from the 1^{st} positive brightness signal, the 1^{st} negative brightness signal, the 2^{nd} positive brightness signal, and the 2^{nd} negative brightness signal.

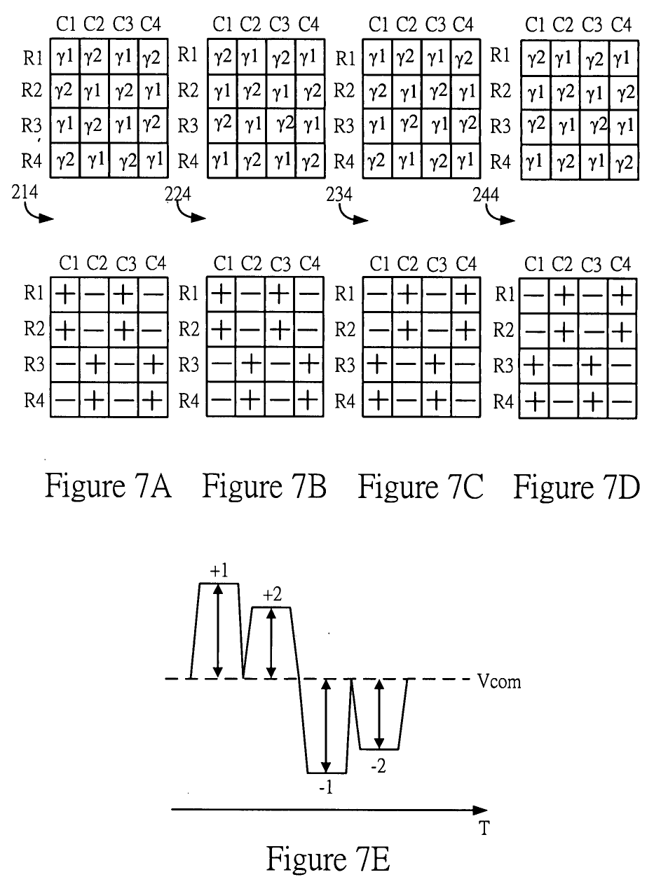

Referring from FIG. 6A to FIG. 6E, FIG. 6A to FIG. 6D are another preferred embodiments of the present invention showing brightness and polarities of frames. FIG. 6E is another preferred embodiment of the present invention showing a waveform diagram of data signals. The preferred embodiments also include 4 frames (212, 222, 232, and 242), and the data signals using to arrange (or layout) are also the 1^{st} positive brightness signal, the 1^{st} negative brightness signal, the 2^{nd} positive brightness signal, and the 2^{nd} negative brightness signal. As shown in FIG. 6E and FIG. 5E, the timing of the data signals in the preferred embodiments are substantially identical as the timing of the data signals in the foregoing preferred embodiments. Besides, the arrangements (or layouts) of polarities in the frames are substantially identical as 2H arrangement (or layout) of the foregoing preferred embodiments. The difference from the foregoing preferred embodiments is on the different brightness arrangements (or layouts). As shown from FIG. 5A to FIG. 5E, the brightness layouts of the frames (210, 220, 230, and 240) are 2H layouts. In other words, under the certain grayscale display status, the gammas in every column change every other 2 unit pixels, such as alternately arrangement in every other 2 unit pixels, but the gammas corresponding to the unit pixels of the frames in the adjacent columns are substantially different. As shown from FIG. 6A to FIG. 6E, the brightness arrangements (or layouts) of the frames (212, 222, 232, and 242) are 2H arrangements (or layouts). The difference between two arrangements (or layouts) is the layout relationship different from the polarities corresponding to the brightness.

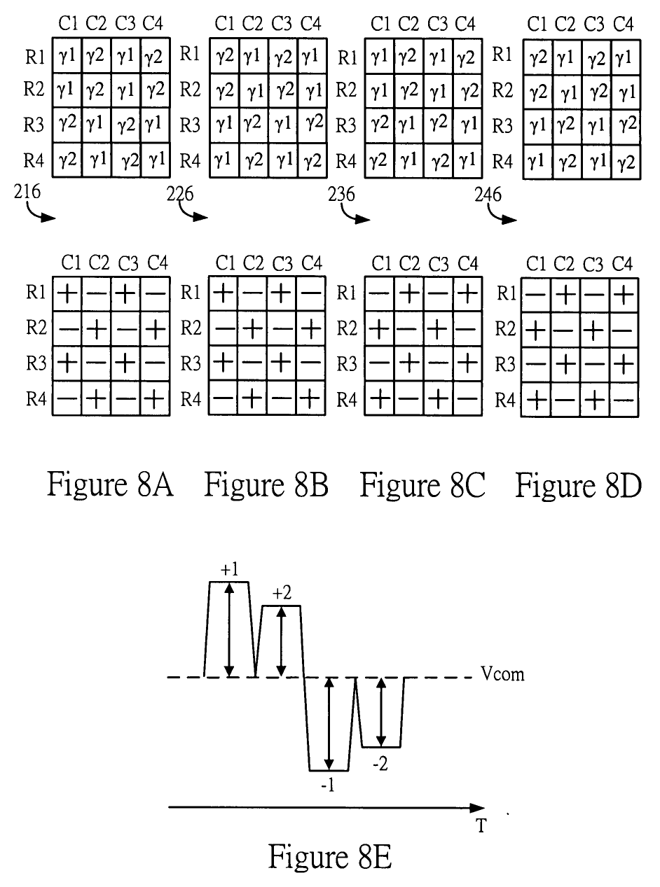

Referring from FIG. 7A to FIG. 7E, FIG. 7A to FIG. 7D are another preferred embodiments of the present invention showing brightness and polarities of frames. FIG. 7E is another preferred embodiment of the present invention showing a waveform diagram of data signals. The preferred embodiments include 4 frames (214, 224, 234, and 244), and the data signals of the unit pixels in 4 frames (214, 224, 234, and 244) are the 1^{st} positive brightness signal, the 1^{st} negative brightness signal, the 2^{nd} positive brightness signal, and the 2^{nd} negative brightness signal. The timing of the data signals of the preferred embodiments is as same as the timing of the data signals of FIG. 6E. Besides, the arrangements (or layouts) of polarities in the frames of the present preferred embodiments are same as 2H arrangement (or layout) of the foregoing preferred embodiments. The brightness arrangements (or layouts) of the frames (214, 224, 234, and 244) in the present invention as shown from FIG. 7A to FIG. 7D is a dot-to-dot arrangement (or layout). In other words, the brightness arrangements (or layouts) of 4 unit frames in the 1^{st} column are interlaced. For example, the brightness arrangements (or layouts) of 4 unit pixels in the 1^{st} column individually are the interlaced arrangements (or layouts) with the 1^{st} brightness and the 2^{nd} brightness. Under the certain grayscale display status, the brightness of the unit pixels of the adjacent columns in the frames of the present invention is substantially different.

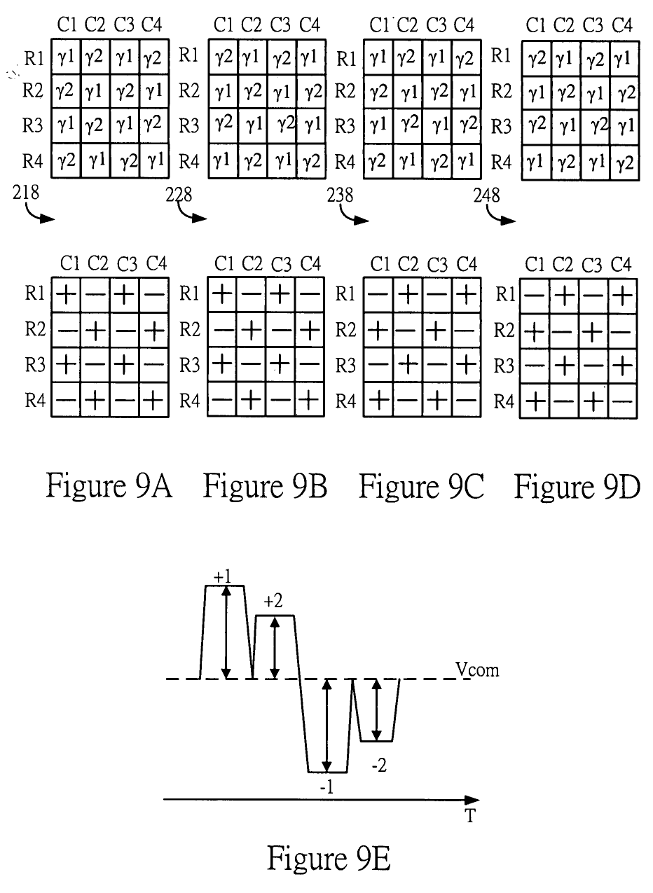

Referring from FIG. 8A to FIG. 8E, FIG. 8A to FIG. 8D are another preferred embodiments of the present invention showing brightness and polarities of frames, and FIG. 8E is another preferred embodiment of the present invention showing a waveform diagram of data signals. The preferred embodiments include 4 frames (216, 226, 236, and 246). As shown in FIG. 8E, the preferred embodiments use the timing of data signals in the foregoing preferred embodiments to arrange (or layout) the unit pixels of the 4 frames (216, 226, 236, and 246). Therefore, the present preferred embodiments are also use the 1^{st} positive brightness signal, the 1^{st} negative brightness signal, the 2^{nd} brightness signal and the 2^{nd} negative brightness signal to layout the unit pixels of 4 frames (216, 226, 236, and 246). As shown from FIG. 8A to FIG. 8D, the brightness arrangements (or layouts) of 4 frames (210, 220, 230, and 240) are 2H arrangements (or layouts) as same as the brightness arrangements (or layouts) of the frames (212, 222, 232, and 242) as shown from FIG. 6A to FIG. 6D. In other words, the brightness of pre-two unit pixels in every column of the frames is substantially identical, and the brightness of post-two unit pixels is substantially identical, but the brightness of the unit pixels of the adjacent columns is substantially different. As shown from FIG. 8A to FIG. 8D, the polarity arrangements (or layouts) of the frames (216, 226, 236, and 246) are all dot-to-dot arrangements (or layouts). In other words, the polarities of the unit pixels in every column of the frames are interlaced arrangements (or layouts) which are different from the polarity arrangements (or layouts) of the frames (212, 222, 232, and 242) as shown from FIG. 6A to FIG. 6D.

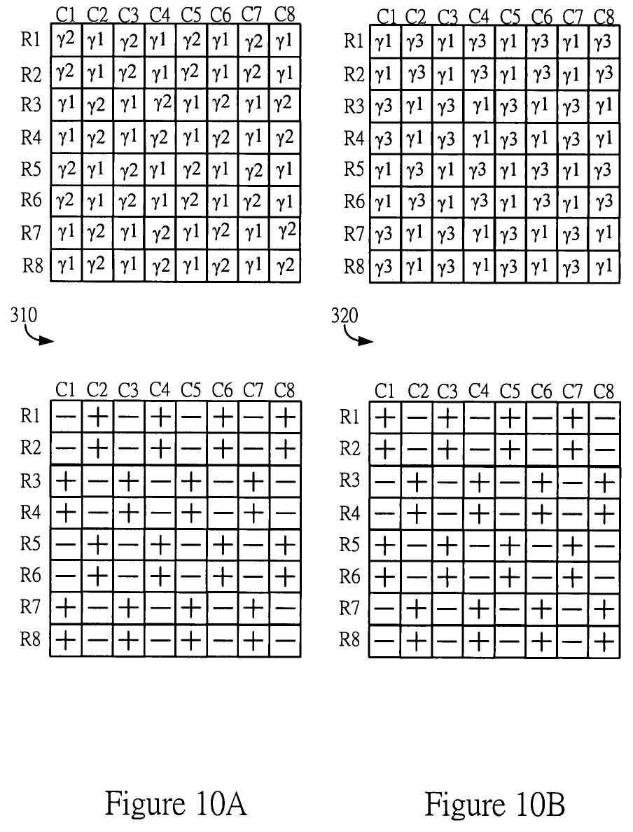

Referring from FIG. 9A to FIG. 9E, FIG. 9A to FIG. 9D are another preferred embodiments of the present invention showing brightness and polarities of frames, and FIG. 9E is another preferred embodiment of the present invention showing a waveform diagram of data signals. As shown from FIG. 9A to FIG. 9D, the preferred embodiments include 4 frames (218, 228, 238, and 248). As shown in FIG. 9E, the timing of the data signals in the present preferred embodiments is similar to the timing of the data signals in FIG. 8E. The present preferred embodiments also use the 1^{st} positive brightness signal, the 1^{st} negative brightness signal, the 2^{nd} positive brightness signal and the 2^{nd} negative brightness signal to layout the unit pixels of 4 frames (218, 228, 238, and 248). As shown from FIG. 9A to FIG. 9D, the brightness arrangements (or layouts) of 4 frames (218, 228, 238, and 248) are dot-to-dot arrangements (or layouts). The polarity arrangements (or layouts) of the frames (216, 226, 236, and 246) as shown from FIG. 8A to FIG. 8D have the same arrangements (or layouts) as the above ones.

According to the above preferred embodiments, the brightness arrangements (or layouts) and the polarity layouts of the frames in the present invention are various, and they are not limited to certain arrangement (or layout) type. There is a common characteristic for the polarity arrangements (or layouts) of the frames in the above preferred embodiments, which is that the polarity arrangements (or layouts) of the pixels of 4 frames in the same position have a rule. The rule can be that polarities change once every other 2 driving unit times. In other words, the polarities of the unit pixels of pre-two frames are substantially identical, and the polarities of the unit pixels of post-two frames are substantially identical. However, the polarities of post-two frames are opposite to the polarities of pre-two frames. For example, the polarities of the unit pixels R1C1 as shown in FIG. 5A and FIG. 5B are all +, and the polarities of the unit pixels R1C1 as shown in FIG. 5C and FIG. 5D are all −. Besides, the polarities of the unit pixels as shown in the foregoing preferred embodiments corresponding to the same brightness in different the driving unit times are substantially different, and the total amount of potential differences is substantially equal to zero. For example, the total amount of potential differences in the unit pixels R1C1 of FIG. 5A and FIG. 5C is substantially equal to zero. The total amount of potential differences in the unit pixels R1C1 of FIG. 5B and FIG. 5D is substantially equal to zero. Therefore, the total amount of voltages differences in the unit pixels R1C1 of 4 frames is substantially equal to zero.

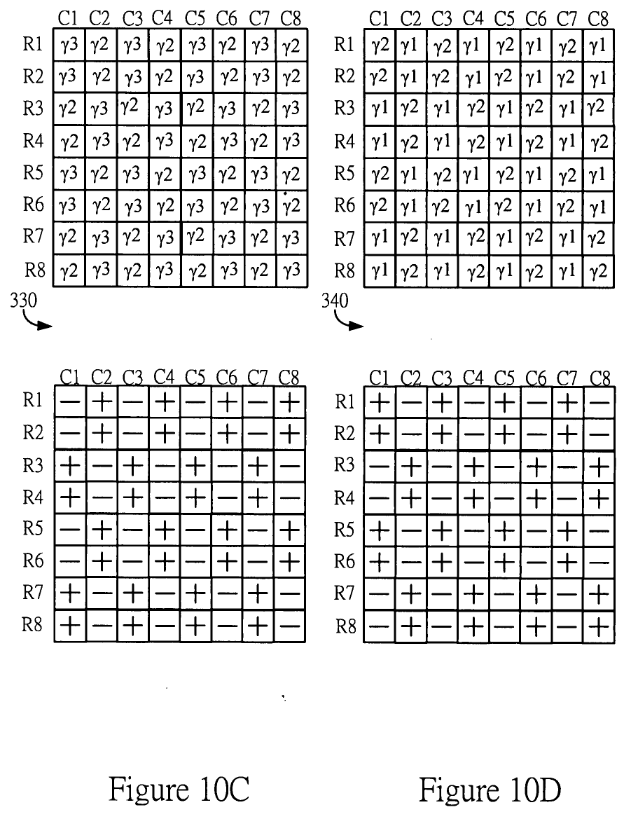

The present invention not only uses the data signals with two different grades of brightness to arrange (or layout) the frames of the display panel, but also uses the data signals with more than two substantially different grades of brightness to layout. As shown from FIG. 10A to FIG. 10F. The preferred embodiments use the data signals with three substantially different grades of brightness to arrange (or layout) 6 frames (310, 320, 330, 340, 350, and 360) in the group time. In other words, the data signals not only include the 1^{st} positive brightness signal, the 1^{st} negative brightness signal, the 2^{nd} positive brightness signal, and negative brightness signal, but also include the 3^{rd} positive brightness signal and the 3^{rd} negative brightness signal corresponding to the 3^{rd} gamma γ₃. The 3^{rd} gamma γ₃ is substantially smaller than the 2^{nd} gamma γ₂. In other words, the brightness of the 2^{nd} positive brightness signal and the 2^{nd} negative brightness signal is substantially greater than the brightness of the 3^{rd} positive brightness signal and the 3^{rd} negative brightness signal. As shown in FIG. 10G, the potential differences corresponding to the 3^{rd} positive brightness signal +3 and the 3^{rd} negative brightness signal −3 are substantially lower than the potential differences corresponding to the 2^{nd} positive brightness signal +2 and the 2^{nd} negative brightness signal −2.

The above preferred embodiments use the brightness signals with different gammas to arrangement (or layout) the brightness of the unit pixels for every frame (310, 320, 330, 340, 350, and 360). The 1^{st} frame 310 conforms to the 1^{st} gamma γ₁ and the 2^{nd} gamma γ₂, the 2^{nd} frame 320 conforms to the 1^{st} gamma γ₁ and the 3^{rd} gamma γ₃, and the 3^{rd} frame 330 conforms to the 2^{nd} gamma Y2 and the 3^{rd} gamma γ₃. The 4^{th} frame, the 5^{th} frame, and the 6^{th} frame follow the 1^{st} frame, the 2^{nd} frame, and the 3^{rd} frame to conform to the corresponding gammas, respectively. The preferred embodiments is based on the timing of FIG. 10G to arrange (or layout) the brightness and the polarities of the unit pixels of the frames (310, 320, 330, 340, 350, and 360) in the same position. As a result, the total amount of potential differences is substantially equal to zero as same as FIG. 10G in case the unit pixels of the frames (310, 320, 330, 340, 350, and 360) are in the same position. More, the residual image will not appear in the display panel while viewing frames, and the residual image can be avoided happening on the display panel for enhancing the display quality.

The timing of FIG. 10 G is one preferred embodiment in the present invention uses data signals with three different grades of brightness. However, the present invention is not limited to the above description. The data signals corresponding to 6 unit pixels of 6 frames in the same position within the group time can be any combination form the 1^{st} positive brightness signal, the 1^{st} negative brightness signal, the 2^{nd} positive brightness signal, the 2^{nd} negative brightness signal, the 3^{rd} positive brightness signal, the 3^{rd} negative brightness signal.

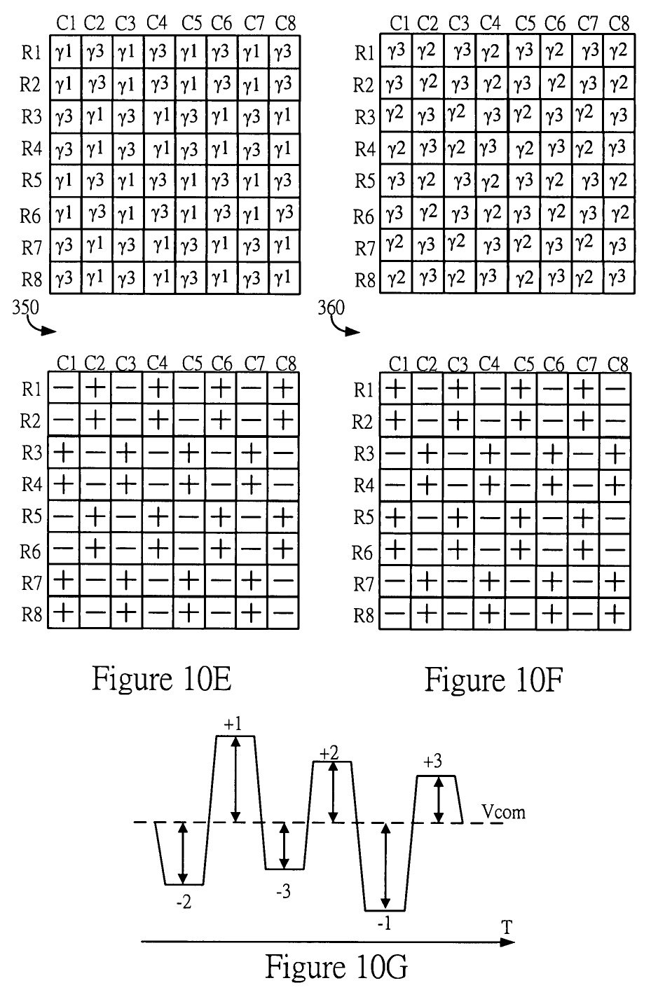

Referring from FIG. 11A to FIG. 11E, FIG. 11A to FIG. 11D are another preferred embodiments of the present invention showing brightness and polarities of frames, and FIG. 11E is another preferred embodiment of the present invention showing a waveform diagram of data signals. However, the present invention is not limited to above description. As shown in FIG. 11E, the timing of the data signals in the present invention is the same as the timing of the data signals in FIG. 5E. However, the voltage of the common voltage source Vcom corresponding to the same unit pixel used in the preferred embodiments is various by time, which is different from the fixed voltage of the common voltage source Vcom as shown in FIG. 5E.

The present preferred embodiments also use the circuit of FIG. 3 to implement, and only require the voltage of the common voltage source Vcom changing by the driving unit times. The change rule is that the voltage changes once every other 2 driving unit times. As shown from FIG. 11A to FIG. 11D, the brightness arrangements (or layouts) of the unit pixels of the frames (410, 420, 430, and 440) in the preferred embodiments are 2H arrangements (or layouts). The arrangements (or layouts) in the present preferred embodiments are same as the brightness arrangements (or layouts) of the unit pixels of the frames (410, 420, 430, and 440) as shown from FIG. 5A to FIG. 5D. The polarity arrangements (or layouts) of the frames (410, 420, 430, and 440) in the present preferred embodiments are in rows. In other words, the polarities of the unit pixels in each column of the frames are interlaced arrangements (or layouts). Further, the polarities of the unit pixels of the frames in the same position change once every other 2 driving unit times.

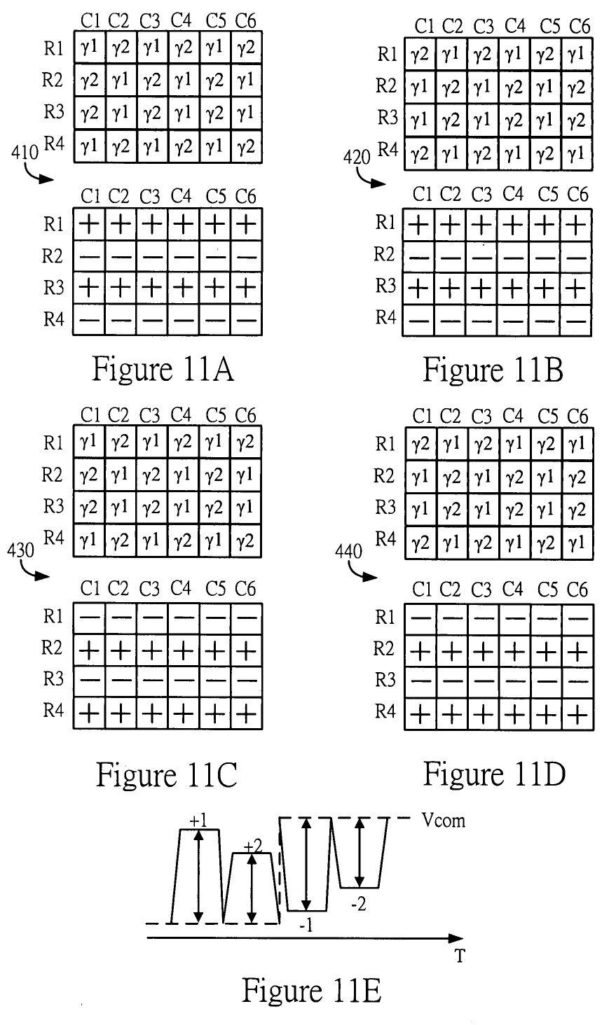

Referring From FIG. 12A to FIG. 12E, FIG. 12A to FIG. 12D are another preferred embodiments of the present invention showing brightness and polarities of frames, and FIG. 12E is another preferred embodiment of the present invention showing a waveform diagram of data signals. However, the present invention is not limited to above description. As shown in FIG. 12E, the timing of the data signals in the preferred embodiment is the same as the timing of the data signals in FIG. 4E. The voltage of the common voltage source Vcom corresponding to the same unit pixel used in the preferred embodiments is various by time, which is different from the fixed voltage of the common voltage source Vcom as shown in FIG. 4E. The voltage of the common voltage source Vcom in FIG. 12E changes once every other driving unit time, which is different from the voltage of the common voltage source Vcom as shown in FIG. 11E changing once every other 2 driving unit times.

As shown from FIG. 12A to FIG. 12D. The brightness arrangements (or layouts) of the unit pixels of the frames (450, 460, 470, and 480) in the preferred embodiments are 2H arrangements (or layouts). Besides, the brightness of the unit pixels of adjacent columns is different. The polarity arrangements (or layouts) of the frames (450, 460, 470, and 480) in the present preferred embodiments are in rows. In other words, the polarities of the unit pixels in each column of the frames are interlaced arrangements (or layouts). Besides, the polarity arrangements (or layouts) in each column of the frames are all identical. These polarity arrangements (or layouts) are same as the ones of the foregoing preferred embodiments. However, the polarities of the unit pixels of 4 frames in the same position change once every other driving unit time, which are different from the ones of the foregoing preferred embodiments.

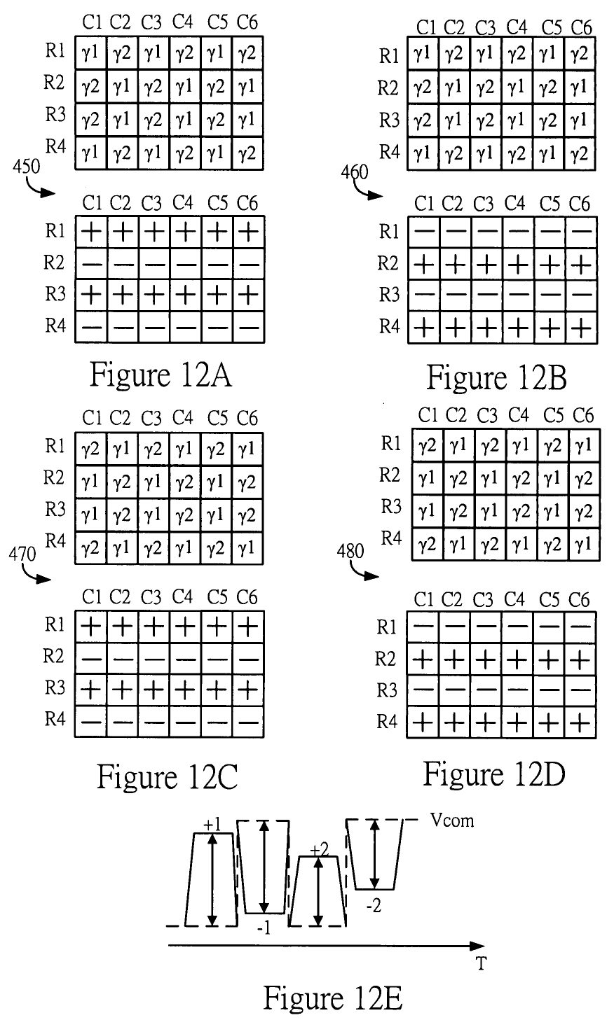

Referring to FIG. 13, the figure is another preferred embodiment of the present invention showing a circuit diagram. However, the present invention is not limited to the above description. The circuit of the preferred embodiment as shown in FIG. 13 is similar to the circuit of the preferred embodiment as shown in FIG. 3. The display panel as shown in FIG. 13 includes a gate driving circuit 20, a data driving circuit 30, a timing controller 40, a plurality of gate lines 60, and a plurality of data lines 70. The gate lines 60 and the data lines 70 are individually arrangement (or layout) in rows and columns and substantially interlaced to form the unit pixels 10. Each unit pixel 10 also includes a switch 12, a storage capacitor 14, and a liquid crystal capacitor 16. The storage capacitor 14 and the liquid crystal capacitor 16 are individually coupled with the switch 12. The timing controller 40 transmitting the timing signals to the gate driving circuit 20 and the data driving circuit 30 in order to provide the timing signals to the gate driving circuit 20 and the data driving circuit 30 for individually transmitting a plurality of gate signals and a plurality of data signals to the switches 10 through the gate lines 60 and the data lines 70 as well as controlling the unit pixels.

The difference between the circuit of the present preferred embodiment and the circuit of FIG. 3 is that the present preferred embodiment has two common voltage sources (80 and 82), and the voltages of two common voltage sources (80 and 82) are various by the driving unit times. As shown in FIG. 13, the 1^{st} common voltage source 80 is coupled with the unit pixels of the odd rows, and generates the potential difference with the unit pixels 10 of the odd rows as well as controls the unit pixels 10 to display. In addition to above, the 2^{nd} common voltage source 82 is coupled with the unit pixels 10 of the even rows, and generates the potential differences with the unit pixels 10 of the even rows as well as controls the unit pixels 10 of the even rows to display.

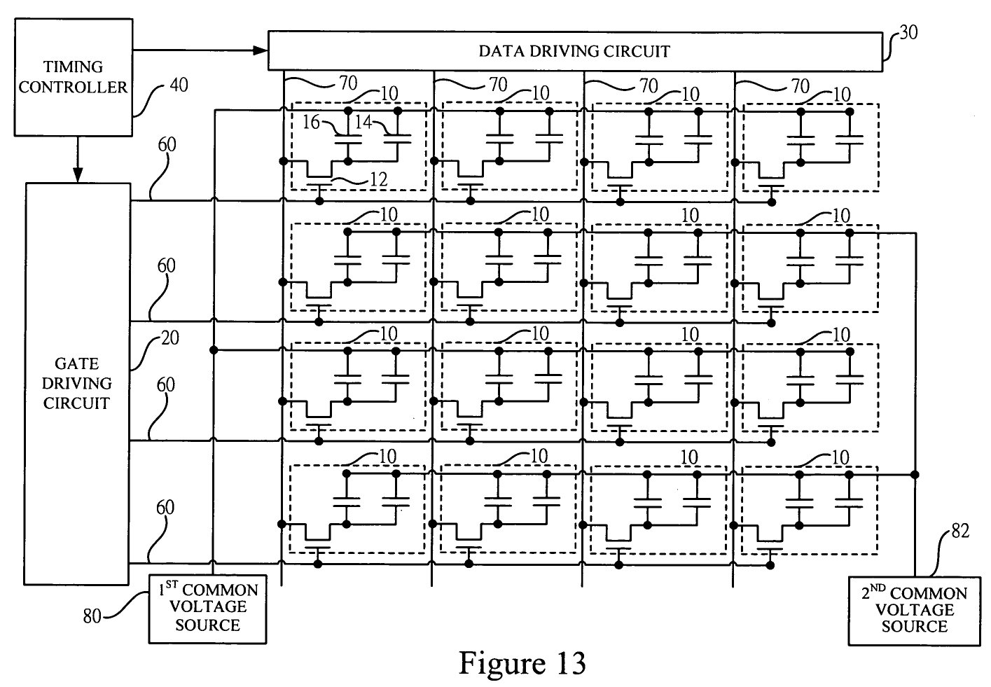

Referring to FIG. 14, the figure is another preferred embodiment of the present invention showing a circuit diagram. However, the present invention is not limited to the above description. The circuit of the preferred embodiment as shown in FIG. 14 is the same as the circuit as shown in FIG. 13. The display panel as shown in FIG. 14 includes a gate driving circuit 20, a data driving circuit 30, a timing controller 40, a plurality of gate lines 60, and a plurality of data lines 70. The gate lines 60 and the data lines 70 are arrangement (or layout) in rows and columns and substantially interlaced to form the unit pixels 10. Each unit pixel 10 also includes a switch 12, a storage capacitor 14, and a liquid crystal capacitor 16. The circuit connection and the action mode in the preferred embodiment are all same as the circuit in FIG. 13. There are some difference between the circuit in FIG. 14 and the circuit in FIG. 13. The common voltage sources (80 and 82) of FIG. 14 are substantially interlaced coupled with the unit pixels 10 in every two rows, and generate the potential differences with the pixel voltages of the unit pixels 10 as well as control the unit pixels 10 to display. The above substantially interlaced coupling method using a substantially interlace coupling every other column, and makes the common voltage sources coupled with the adjacent unit pixels be substantially different.

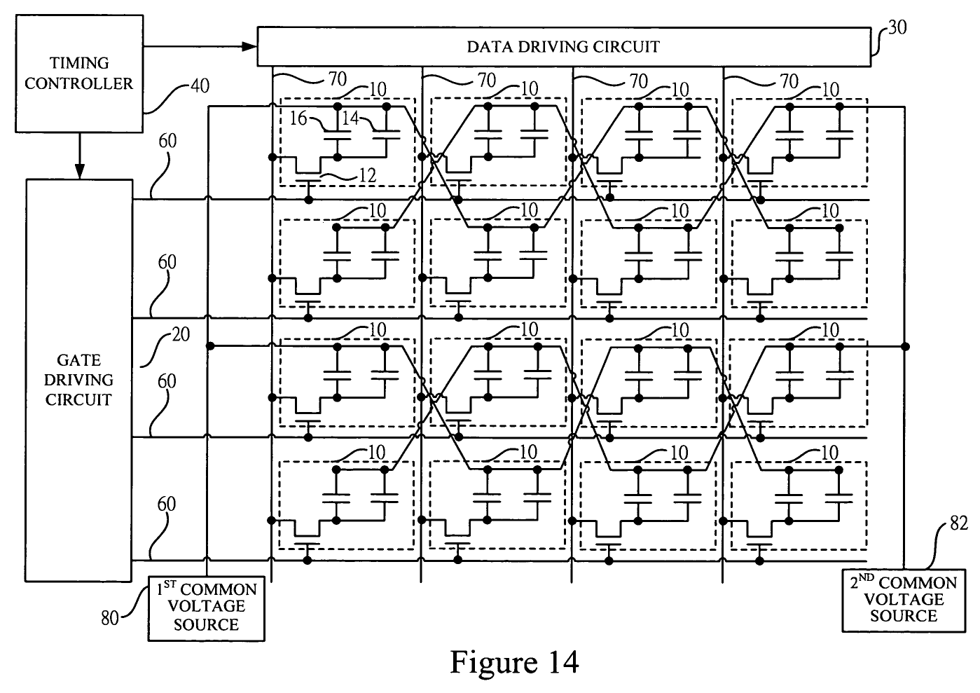

Referring to FIG. 15, the figure is another preferred embodiment of the present invention showing a waveform diagram of data signals. The preferred embodiment of FIG. 15 should be accomplished in accordance with the circuit of FIG. 13 or FIG. 14. As shown in FIG. 15, the timing arrangements (or layouts) of the preferred embodiment are the 1^{st} positive brightness signal, the 1^{st} negative brightness signal, the 2^{nd} positive brightness signal, and the 2^{nd} negative brightness signal as same as the timing arrangements (or layouts) of FIG. 4E. The preferred embodiment of FIG. 15 and the preferred embodiment of FIG. 4E have some differences. The common voltage source in FIG. 15 includes two, but the common voltage source in FIG. 4E only includes one. Besides, the voltages of the 1^{st} common voltage source and the 2^{nd} common voltage source in the same pixel are various by time, which are substantially different from the fixed voltage of the common voltage source Vcom in FIG. 4E. The voltages of two common voltage sources in the present preferred embodiment will be changed every other driving unit time. The voltage directions of two common voltage sources in the present preferred embodiment are substantially different in the same driving unit time. Therefore, the voltages of two common voltage sources are substantially different.

Since FIG. 15 includes 2 common voltage sources, the data signals with two substantially different grades of brightness in the preferred embodiment will correspond to the common voltage sources with potential differences. The preferred embodiment of FIG. 15 comes out by conforming to above method, and represents the brightness with 4 substantially different gammas (1, 2, 1*, 2*). Therefore, under the same gamma, a plurality of domains is divided into more domains for achieving better viewing angle. The voltages of two common voltage sources in the preferred embodiment are substantially identical by time, but the polarities are opposite. Therefore, the total amount of the adjusted voltages of the common voltage sources in the preferred embodiment can keep as zero, and residual charge will not appear.

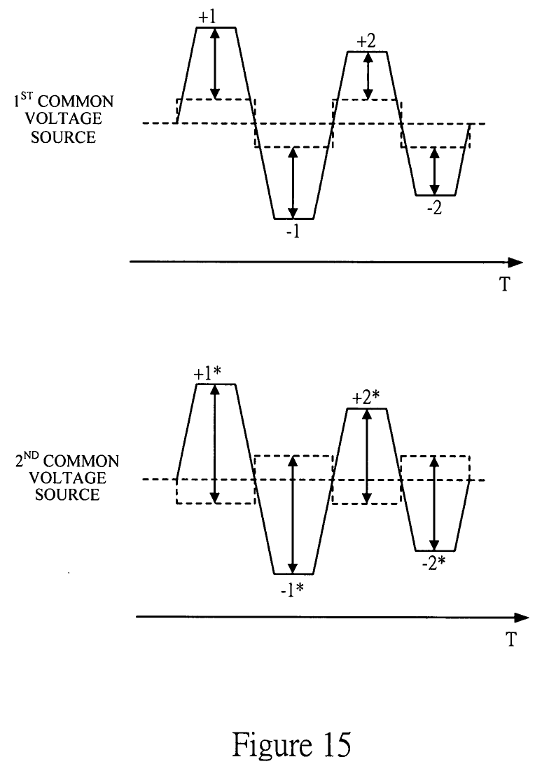

Referring to FIG. 16, the figure is another preferred embodiment of the present invention showing a waveform diagram of data signals. As shown in the figure, the timing arrangements (or layouts) of the preferred embodiment are the 1^{st} positive brightness signal, the 2^{nd} positive brightness signal, the 1^{st} negative brightness signal, the 2^{nd} negative brightness signal as same as the timing arrangements (or layouts) of FIG. 5E. This present preferred embodiment is the same as the foregoing preferred embodiment, which includes two common voltage sources. The voltages in the unit pixels are various by time, and the change rule of the voltages of the common voltage sources is changing once every other 2 driving unit times which is different from the change rule in the foregoing preferred embodiment. The voltage directions of the 1^{st} common voltage source and the 2^{nd} common voltage source in the present preferred embodiment are substantially different in the same driving unit time. Therefore, the common voltages of the 1^{st} common voltage source and the 2^{nd} common voltage source are substantially different. Further, the present preferred embodiment is as same as the foregoing preferred embodiment which can represent the brightness with different gammas. Besides, the present preferred embodiment is also as same as the foregoing preferred embodiment that the voltages of two common voltage sources are substantially identical arrangements (or layouts) in the same driving unit time but the polarities are opposite. Therefore, the total amount of the adjusted voltages of the common voltage sources in the preferred embodiment can keep in substantially equal to zero, and residual charge will not appear.

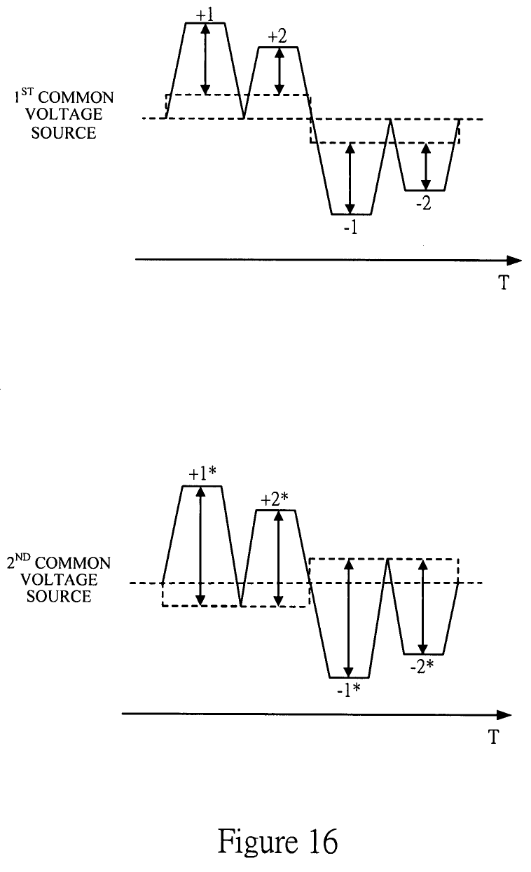

Referring to FIG. 17, the figure is another preferred embodiment of the present invention showing a waveform diagram of data signals. As shown from FIG. 17 and FIG. 10G, the timing arrangements (or layouts) of FIG. 17 are same as the timing arrangements (or layouts) of FIG. 10G The present preferred embodiment also conforms to the circuit of FIG. 13 and FIG. 14 to implement, which includes 2 common voltage sources as same as the preferred embodiment in FIG. 15. The voltages under the same unit pixel will change once every other driving unit time. Further, the voltage directions of two common voltage sources are substantially different in the same driving unit time. The present preferred embodiment uses the data signals with three substantially different grades of brightness in accordance with the common voltage sources with two potential differences to represent the brightness with 6 substantially different gammas (1, 2, 3, 1*, 2*, 3*). Besides, the present preferred embodiment is also as same as the foregoing two preferred embodiment that the voltages of two common voltage sources are substantially identical arrangements (or layouts) in the same driving unit time but the polarities are opposite. Therefore, residual charge will not result.

According to the above description, the driving method of the present invention is used to apply in the display panel. The driving method of the present invention can transmit the data signals with different brightness to the unit pixels of the frames through the data lines in order to control the unit pixels within the group time. More, the total amount of voltages difference in each unit pixel in the group time is substantially equal to zero. Therefore, residual charge can be avoided resulting in the frames of the display panel. Further, the residual image appearing on the frames caused from the residual charge can be avoided for enhancing the display quality. More, the unit time with different brightness within the group time can perform the predetermined brightness.

Further, the group time in the above preferred embodiments of the present invention illustrates that the frames use an adequate frequency to switch. One preferred example in the present invention is to switch by the frequency between about 60 Hz and about 120 Hz substantially. However, if the frequency substantially is substantially smaller than 60 Hz or substantially greater than 120 Hz, it is still applicable to the preferred embodiments of the present invention.

More, the common voltage sources Vcom of the preferred embodiments of the present invention as shown from FIG. 4A to FIG. 10G use DC type. For example, the voltage of the common voltage source is about 5V˜about 6V, but does not mean the voltage is limited to these range. Besides, the above DC-type preferred embodiments also can apply to Figures from 11A to 12E. Indeed, the common voltage source Vcom also can use AC type to apply into Figures from 4A to 10C and the voltage of the common voltage source is not limited to any number. The common voltages sources (80 and 82) of the preferred embodiments as shown from FIG. 11A to FIG. 12E use AC type. For example, the common voltage sources (80 and 82) are AC voltages. The voltages are substantially about 3V˜about 7V, and the amplitudes (ΔV) are about 4V. However, the voltages are not limited to the above voltage range. Further, the above AC-type preferred embodiments also can apply to Figures from 4A to 10G. Besides, sine AC-type can be used as well as used with cosine.

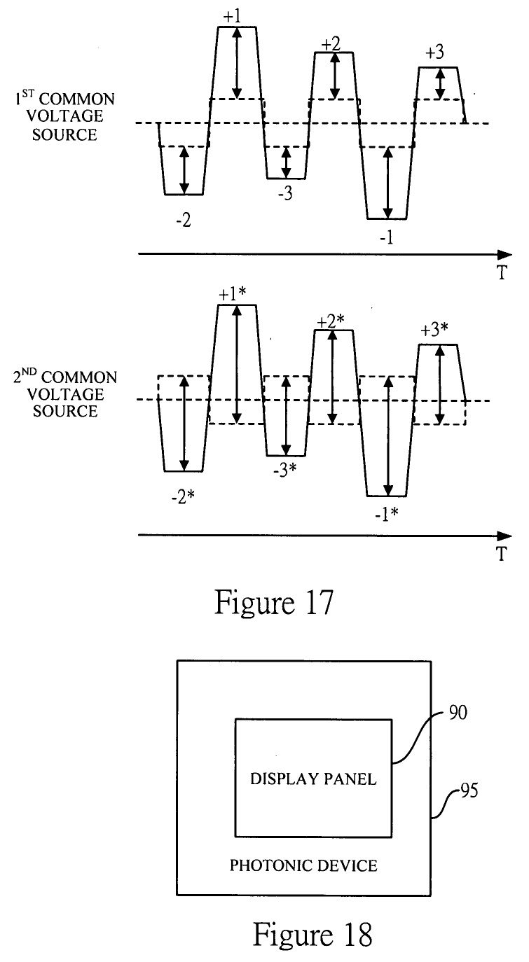

More, the method of the present invention can apply to various display panels, such as multi-domain vertical alignment LCD (MVA-LCD), vertical alignment LCD (VA-LCD), polymer stabilized alignment LCD (PSA-LCD), in-plane switch LCD (IPS-LCD), optically compensated bend LCD (OCB-LCD), twisted nematic LCD (TN-LCD), super twisted nematic LCD (STN-LCD), or other related LCD. As shown in FIG. 18, display panel 90 can be applied into a electro-optic device 95, and the electro-optic device 95 includes more components (not shown), such as controlling component, operating component, processing component, input component, memory component, driving component, other functional component, or combinations thereof.

Although the present invention has been described in terms of particular embodiments in an application, one of ordinary skill in the art, in light of the teachings herein, can generate additional embodiments and modifications without departing from the spirit of, or exceeding the scope of, the present invention. Accordingly, it is understood that the drawings and the descriptions herein are proffered only to facilitate comprehension of the invention and should not be construed to limit the scope thereof.

What is claimed is:

1. A method for driving a display panel having a plurality of unit pixels and a plurality of switches used to control the unit pixels, the method comprising:
transmitting a plurality of gate signals to the switches to drive thereof; and
transmitting a plurality of data signals to the switches to provide a plurality of pixel voltages to the unit pixels respectively and providing a common voltage to the unit pixels, so as to generate potential differences between the common voltage and the pixel voltages in the unit pixels respectively, adapted to drive each the unit pixel to display in a group time, and the total amount of the potential differences of each the unit pixel in the group time is substantially equal to zero;
wherein the group time includes a plurality of driving unit times, at least one group of pixels with at least one of the unit pixels displays in each the driving unit time.

2. The method of claim 1, wherein the at least one group of unit pixels includes a plurality of grayscale levels of brightness and the total brightness of the group of pixels accords with a pre-determined brightness.

3. The method of claim 1, wherein the group time includes four driving unit times, and the data signal corresponding to each the unit pixel in the driving unit time is any one of a first positive brightness signal, a first negative brightness signal, a second positive brightness signal, and a second negative brightness signal.

4. The method of claim 3, wherein the ratio of the total brightness of the first positive brightness signal and the first negative brightness signal to the total brightness of the second positive brightness signal and the second negative brightness signal is any number.

5. The method of claim 3, wherein the data signals corresponding to any four of adjacent unit pixels by 2×2 in the frames are any combination from the first positive brightness signal, the first negative brightness signal, the second positive brightness signal and the second negative brightness signal.

6. The method of claim 1, wherein the driving unit time comprises a time of displaying a frame.

7. The method of claim 1, wherein the driving unit time comprises a time of displaying a sub-frame.

8. The method of claim 1, wherein the group time includes four driving unit times, and a plurality of polarities of the data signals corresponding to each the unit pixel in the driving unit times have a rule is that the polarities change once in any two of the driving unit times.

9. The method of claim 1, wherein the group time includes four driving unit times, and a plurality of polarities of the data signals corresponding to each the unit pixel in the driving unit times have a rule is that the polarities change once in any one of the driving unit times.

10. The method of claim 1, wherein the group time includes six driving unit times, and the data signal corresponding to each the unit pixel in the driving unit time is any one of a first positive brightness signal, a first negative brightness signal, a second positive brightness signal, a second negative brightness signal, a third positive brightness signal, and a third negative brightness signal.

11. The method of claim 1, further comprising adjusting a potential of a common voltage source to adjust the common voltage according to at least one of the driving unit times.

12. The method of claim 11, wherein the common voltage source includes a first common voltage source and a second common voltage source.

13. The method of claim 12, wherein a first common voltage of the first common voltage source and the pixel voltages of the unit pixels in odd rows have the first potential differences and a second common voltage of the second common voltage source and the pixel voltages of the unit pixels in even rows have the second potential differences.

14. The method of claim 11, wherein the first common voltage source and the second common voltage source are interlaced and coupled to two rows of the unit pixels to provide a first common voltage and a second common voltage, so as to generate the potential differences with the pixel voltages of the unit pixels and the first common voltage and the second common voltage sources, wherein the first common voltage source and the second common voltage source are interlaced and coupled to two rows of the unit pixels in every other column.

15. The method of claim 1, wherein the switches comprise a plurality of transistors.

16. The method of claim 1, wherein the least one group of pixels includes a plurality of the unit pixels having a plurality of grayscale levels of brightness, so that the at least one group of pixels generates a pre-determined brightness by combined the unit pixels.

17. The method of claim 1, wherein the unit pixels displaying in the driving unit times of the group time have different brightness in the different driving unit times, so as to generate a pre-determined brightness by combined the unit pixels in the driving unit times.

18. The method of claim 1, wherein the group time includes four driving unit times, and a plurality of polarities of the data signals corresponding to each the unit pixel in the driving unit times have a rule is that the polarities change once in any two of the driving unit times, and the potential differences of each the unit pixel in any two of the driving unit times is substantially identical.

19. An electro-optic device incorporating the method of claim 1.
